(19) United States
(12) Patent Application Publication
(10) Pub. No.: US 2008/0253565 A1
(43) Pub. Date: Oct. 16, 2008

(54) Encrypted Content Parallel to Free Broadcast

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,618

(22) PCT Filed: Feb. 5, 2005
(86) PCT No.: PCT/IB2005/050274

§ 371 Date: Aug. 1, 2006

(30) Foreign Application Priority Data
Feb. 5, 2004 (EP) 04100418.5

(51) Int. Cl. H04L 9/00

(52) U.S. Cl. 380/255

(57) ABSTRACT

The present invention relates to a method and a device (103) for acquiring content from an information transmission (101). The invention is based on the idea that an information transmission is received via a transmission channel. Along with the information transmission, which e.g. is a broadcast from a radio show, an encrypted, digitally storable version of the broadcast is transmitted and received (102) by a listener. On the receiver, the listener can effect a download operation of a song that is currently played by means of e.g. pressing a dedicated key on the receiver front end, the receiver extracts the encrypted, digitally storable copy of the song from the information broadcast and downloads it to a storage capacity in connection to the receiver. The listener can thereafter choose to replay the downloaded song by effecting a replay operation. The receiver will thus decrypt the encrypted content and render the downloaded content.

The present invention relates to a method of acquiring content from an information transmission and a device for acquiring content from an information transmission.

Ever since the introduction of small one-chip broadcast radio receivers, the price of adding FM broadcast radio reception to an electronic device has steadily decreased. In recent years, this facility has more or less been part of the standard features for mobile phones.

The Radio Data System (RDS) is a standard for enabling a radio listener to scan for a particular type of program without repeatedly having to operate the radio tuning dial. Moreover in RDS, data can be embedded into the FM radio signal. RDS is used for station identification and classification. More recently, RDS has been used for sending other types of data, such as traffic information, to car radio receivers. A specific application of RDS is the Traffic Message Channel (TMC), which is used for broadcasting real-time traffic and weather information and, in particular, navigation information, which is known as dynamic route guidance. Radio data are received and decoded by a TMC-equipped car radio and the resulting information is delivered visually or audibly to the driver.

Digital Audio Broadcasting (DAB) is a digital radio broadcast system that offers data services next to compressed music. DAB can be used as a carrier of RDS-TMC signals. The Multimedia Object Transfer (MOT) specification allows DAB to carry text and graphics, still and moving pictures, Internet pages etc. Copyright control, conditional access, value-added services can be implemented in DAB with different data capacities and local, regional or national service coverage using terrestrial and/or satellite-based transmitters.

In today's information society, the rapid spread of digital information has given birth to the concept of digital rights management (DRM). This concept is used to protect the rights of a creator of the digital information, typically called the digital content, as well as the rights of an information provider distributing the information or content. This concept is applicable to information distributed via any type of media, such as radio, the Internet, a CD, a DVD or the like. It is also applicable to any type of information, for example audio, video, text etc. DRM technologies are thus used to protect copyrighted content from being pirated, misused and/or wrongly distributed. Thus, DRM technologies can be implemented in a system such as DAB to protect distributed data and to help broadcasters generate revenue. Typically, in DRM systems, so called digital rights are associated with the distributed content. The digital rights indicate what access its user is given to the content. Common digital rights are “play”, “copy”, “burn to CD-R”, “transfer”, “download” etc. A typical digital right associated with audio content is “play unlimited”. However, limited digital rights are also common, giving its user access to content, to which the rights are associated, a limited number of times, for example “play for 24 hours”.

The published European patent application EP 1 113 605 discloses methods and apparatus for identification of broadcast digital music and other types of information. In EP 1 113 605, identification information is extracted from a current broadcast of a piece of music, or other type of information of interest to a user, and stored in a storage device in response to a user command. The identification information includes sufficient information to identify at least one deliverable information item associated with the current broadcast, being for example a CD or an MP3 file, which contains the particular piece of music.

When the user later has access to a wired or wireless network connection, the extracted identification information is delivered over a network connection to a server that processes the delivered information to identify the deliverable information item associated with the broadcast. The user can then purchase the deliverable information item by appropriate interaction with the server.

A problem with the disclosure of EP 1 113 605 is that, as identifiers are embedded in the broadcast information, after having extracted the identification information, the user must establish a connection with the server for acquiring the information item associated with the identification information of the broadcast. A user who purchases information items repeatedly will most likely perceive this procedure as tedious and inconvenient.

An object of the present invention is to overcome the above given problem and provide a solution in which a user regards the acquisition of a desired piece of content that is transferred via, for example, a radio channel or the Internet as straightforward and flexible.

Another object of the present invention is to enable a content provider to securely transfer data over a transmission channel.

Further, it is an object of the present invention to provide a solution that permits conditional access, such that the provider of the transmitted content, or the holder of the copyrighted content, is not damaged by unauthorized content distribution/reception.

These objects are attained by a method of acquiring content from an information transmission according to claim 1 and a device for acquiring content from an information transmission according to claim 8.

According to a first aspect of the invention, a method is provided in which an information transmission is received. The information transmission comprises a first content and an encrypted second content, the second content being a digitally storable copy of the first content. The encrypted second content that is comprised in the received information transmission is extracted from the transmission when a receiver effects an extracting operation. The encrypted second content is then stored at the receiver. Finally, the encrypted second content is decrypted, whereby the second content is made renderable.

According to a second aspect of the invention, a device is provided in which means is arranged to receive an information transmission, which transmission comprises a first content and an encrypted second content, the second content being a digitally storable copy of the first content. Further, the device comprises means for extracting the encrypted second content comprised in the information transmission, when the device is operated to effect an extracting operation, and means for storing the encrypted second content at the device. Moreover, the device is arranged with means for decrypting the encrypted second content, whereby the second content is made renderable. The present invention is based on the idea that an information transmission is received via an appropriate transmission channel. The system in which the present invention can be applied may, for example, be a DAB system or a digital AM/FM radio system, but the system employed may also comprise an Internet based system or a satellite broadcast system, or any other transmission system that allows the application services described herein. A number of transmission types are envisaged, such as broadcast, multicast or any cast, even though the present disclosure mainly describes broadcast transmission.

Along with the information transmission, which e.g. is a broadcast from a radio show, an encrypted, digitally storable version of the broadcast, or a part of the broadcast, is transmitted and received by a listener of the radio show. Preferably, only parts of the broadcast that listeners may wish to download is sent in the encrypted, digitally storable version, such as songs in case the broadcast is a radio show. Thus, the information broadcast can be seen as comprising two different types of content: a first content which is the actual information that the listener is subject to and a second encrypted, digitally storable content being a copy of the first content.

On the receiver, the listener can effect a download operation of a song that is currently played and transmitted over the channel. If the listener wishes to download the song, by means of e.g. pressing a dedicated key on the receiver front end, the receiver extracts the encrypted, digitally storable copy of the song from the information broadcast and downloads it to a storage capacity in connection to the receiver. The listener can thereafter choose to replay the downloaded song by effecting a replay operation. The receiver will thus decrypt the encrypted content and render the downloaded content.

The present invention is advantageous, since it is possible for a user to download encrypted digital information comprised in a broadcast. Further, it is not necessary for the user to establish a dedicated connection to a service provider for downloading the content of interest. The user will experience this as a smooth and flexible way to acquire desired content. By employing a DRM system using cryptographic protection, it is possible for a content provider to securely transfer data over a broadcast channel. Furthermore, by employing a DRM system, the management of rights that authorized users have to access protected content will be greatly facilitated. The present invention prevents the proprietor of the copyrighted content and/or the content provider from being harmed by unauthorized content distribution/reception.

According to an embodiment of the invention, a first decryption key, which is comprised in the received information transmission, is extracted for decrypting the encrypted second content. This first decryption key is also encrypted and a corresponding second decryption key must be acquired from the content provider for decrypting the encrypted first decryption key.

Thus, cracking the first decryption key that accompanies the encrypted digital second content does not jeopardize the security of other broadcasted content. This gives the broadcaster flexibility in choosing the keys used to protect the second content. The second key for decrypting the first key can be distributed beforehand, e.g. on a CD that the user buys from the content provider or a distributor associated with the provider.

According to another embodiment of the present invention, the first content and the encrypted second content are received on separate channels. This is advantageous as compared to using one common channel, due to possible bandwidth limitations of the common channel. The one channel may not have enough spare bandwidth required to send the second digitally storable content. Moreover, the broadcaster may not want to send more data than absolutely necessary over the channel carrying the information that the listener is subject to. This is also advantageous, since the separate channels to some extent can be operated by different providers. Where separate channels are used, it may be necessary to coordinate the first content and the encrypted second content with each other on the separate channels. It also gives the broadcaster greater freedom to manage the two different types of information separately.

According to a further embodiment of the present invention, the first content and the encrypted second content are received on the same channel. This has the advantage that the broadcaster avoids the information overhead that will arise when using separate channels.

For example, the broadcast production will be easier, and coordination of the broadcast content and the digitally storable content will not be necessary to the same extent, because the broadcast content and the digitally storable content are carried in the same stream. Hence, the timing of the broadcast is automatically linked to the timing of the digitally storable content. Further, hardware requirements at the reception device will be reduced as well as the cost of operating a second, separate channel.

Further features of, and advantages with, the present invention will become apparent when studying the appended claims and the following description. Those skilled in the art realize that different features of the present invention may be combined to create embodiments other than those described in the following.

Preferred embodiments of the present invention will be described with reference made to the accompanying drawings in which:

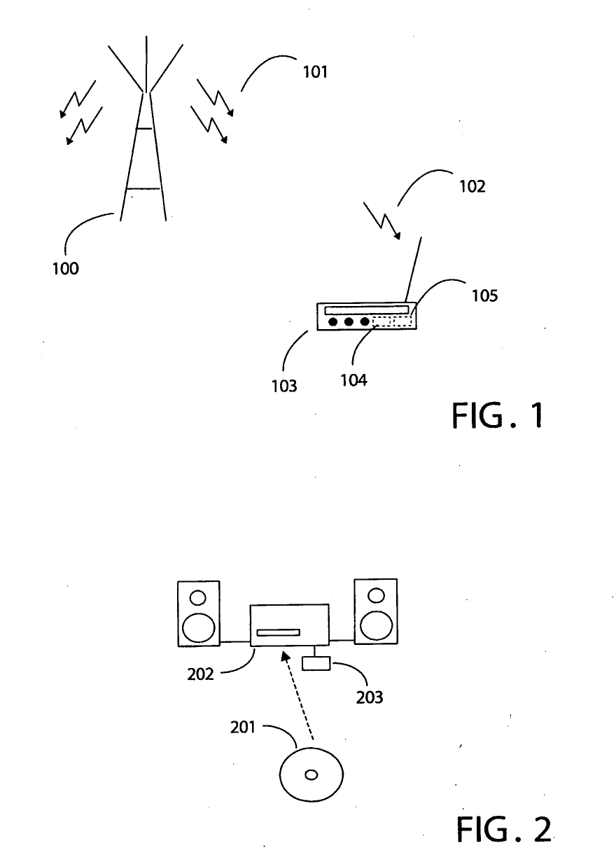

FIG. 1 shows a system in which the present invention advantageously can be employed;

FIG. 2 illustrates rendering of the acquired content according to an embodiment of the invention;

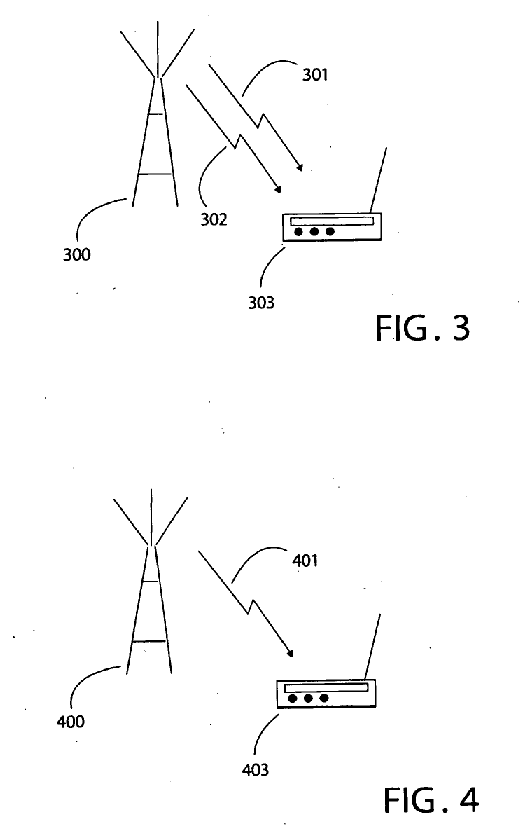

FIG. 3 shows that primary and encrypted secondary content may be transmitted on separate channels according to an embodiment of the invention; and

FIG. 4 shows that primary and encrypted secondary content may be transmitted on the same channel according to another embodiment of the invention.

FIG. 1 shows a conventional broadcast system, for example an FM radio system, in which the present invention can be implemented. A broadcaster 100 effects a transmission 101 of a radio show via the air interface. A radio show is broadcasted on a certain channel in the FM spectrum. The broadcast information, i.e. the information that a listener will be subject to, is hereinafter referred to as primary content. At a receiver 103, reception 102 of the broadcast will occur. The receiver comprises receiving circuitry, in this case an FM receiver 104, and further a microprocessor 105 for performing processing of data, such as extracting information from the received transmission, decryption and encryption, as will be described in the following. Every now and then, songs are broadcasted that a listener at the receiver later may want access to. The listener can of course create a copy of the analog reception by recording the received radio show. This recording can, for example, be performed on an analog audio cassette or a digital MiniDisc. This procedure typically has the drawback that, once the listener has started to record the song, five to ten seconds of the song may already have elapsed, under assumption that the recording device in advance has been provided with a recording medium. If not, a considerably longer time period may have elapsed before the listener has located a recording medium and set the recording device. The more time that has elapsed of the song, the less meaningful the listener considers the recording to be. Another drawback is that a high quality recording is hard to achieve as the analogue signal is recorded. Moreover, there is also the problem that many disc jockeys (DJs) tend to talk during parts (especially the fade-in/fade-out parts) of the song or do not broadcast the entire song.

Further, this procedure may harm the proprietor of the copyrighted content and/or the content provider in that the proprietor/provider really has no control over the distributed content. There is no way to charge a content consumer in the above described scenario.

According to the present invention, an encrypted, digitally storable version of the broadcast, or a part of the broadcast, is transmitted along with the primary content and received by the listener. The digitally storable version, being for example an MP3 file, is referred to as secondary content in the following. Preferably, only secondary content that relates to primary content that the listener is likely to want to download is transmitted. Typically, a radio show contains monologues, news, dialogues between the radio announcer and listeners, as well as contents such as songs, which are considered desirable for listeners to download. Hence, as previously mentioned, the information broadcast 102 can be seen as comprising two different types of content: a first content—primary content—which is the actual information that the listener is subject to and a second encrypted, digitally storable content—secondary content—being a copy of the first content. Preferably, the secondary content is compressed in order to save bandwidth of the channel via which the secondary content is transferred.

The receiver 103 is provided with a function that enables a user to download a desired song, when the song features on the radio show. Typically, the listener presses a key on the receiver for this purpose, whereby the receiver acquires the secondary content. On the transmission channel, the broadcaster transmits the encrypted secondary content, and when the listener effects a download, the receiver will (possibly after a short wait) extract the encrypted and compressed secondary content and store it in connection to the receiver, on some appropriate storage capacity, for example a Small Form Factor Optical (SFFO) disc (see FIG. 2). The broadcaster may transmit the encrypted secondary content repeatedly. It may also be the case that the broadcaster transmits it only once, possibly with a delay to give the user the opportunity (i.e. time) to decide whether or not she wants to acquire the content. Another feasible model would be that the receiving device extracts all secondary content that the user subscribes to, or is entitled to. If, by the end of the song, the user has not indicated that she wants to keep the song, it will be marked for deleting and be deleted the next time amount of storage capacity is an issue. As the subscriptions may specify only a limited number of extractions, the express selection by the user is required to keep the song.

When the extraction of content is finished and the downloading is completed, the receiver will accordingly give the user an indication thereof, for example visually via a receiver display or audibly via receiver speakers.

The encrypted secondary content now resides on a storage capacity of the listener. However, without the corresponding decryption key(s), the listener has no possibility to render the content. If the listener has not already acquired access to the decryption key, she is required to do so, if she wants to render the content.

If the transmission channel offers a low data rate, which is the case in e.g. RDS, a schedule for transmission is embedded during or immediately after a song. The schedule for transmission is embedded in the broadcast and details when and from which channel the song can be acquired. The decryption key(s) will comply with the schedule. In this way, multiple radio shows can refer to the same transmission of an encrypted secondary content.

Note that in FIG. 1, the present invention is applied in an FM radio system, but a person skilled in the art can envisage various communication systems in which the invention can be applied, such as AM radio, Internet radio, satellite broadcast systems etc.

With reference made to FIG. 2, the listener has bought a decryption key from the specific radio station from which the present content was transmitted, or from some key distributor with which the radio station has a key distribution agreement. The key may be stored on a disc 201 that the listener enters into a rendering device 202, to which device a storage capacity 203, e.g. an SFFO disc, which holds the content is connected. The device is also provided with an existing DRM system, e.g. Sapphire, which ensures that the secondary content cannot be distributed once it is in the clear, unless the listener actually has acquired a digital right associated with the content, which right permits her to do so. The digital right that indicates the user's access to the content is typically stored on the disc together with the decryption key. Note that unlimited distribution rights (or even limited distribution rights for that matter) are rather rare, as the content provider thereby loses control over the distribution of content. Further note that the proposed delivery of keys on a disc means that a physical item can be used to draw people to a radio broadcast, which has many promotional benefits and opportunities.

According to an embodiment of the present invention, the broadcaster 100 includes a first decryption key in the information broadcast 101. This first decryption key may, for example, be attached to the encrypted secondary content. The first decryption key corresponds to the encryption key with which the secondary content was encrypted. In this embodiment, when the receiver 102 extracts the encrypted secondary content as described in connection to FIG. 1, it also extracts the first decryption key. Further, the first decryption key is encrypted and a corresponding second decryption key must be acquired from the content provider for decrypting the encrypted first decryption key. The second decryption key is identical with the decryption key that was discussed in the embodiment described with reference made to FIGS. 1 and 2. When the second decryption key has been used to decrypt the encrypted first key, the first key is used to decrypt the encrypted secondary content, whereby the secondary content is ready to be rendered.

This “two-key” approach enhances security in the system, since the more (meaningful) data you encrypt/decrypt using one and the same key, the more likely it is that the key is cracked. Hence, there is some security advantage in encrypting each song in its own key.

However, the primary advantage is that the approach increases flexibility. For example, suppose a listener has two types of subscriptions: (i) all songs by the Sugababes (associated key is K3) and (ii) all songs from a certain DJ (associated key is K9). If this particular DJ includes a Sugababes song in his show, both subscriptions would give the listener rights to the song. Thus, the song is encrypted using the previously mentioned first encryption key, and the corresponding first decryption key is encrypted using K3 and K9 (which keys correspond to the previously mentioned second decryption key), which prevents data from being sent twice.

With reference made to FIG. 3, according to an embodiment of the invention, the primary and encrypted secondary content are received on separate channels. The broadcaster 300 transmits the primary content on a first channel 301 having a first carrier frequency, and the secondary content on a second content 302 having a second carrier frequency. The receiver 303 demodulates the first channel to render the primary content. It is not necessary for the receiver the demodulate the second channel until the secondary content is to be extracted. Note that in the case of separate channels, it is not necessarily the same broadcaster the transmits the primary and the secondary content. A major advantage associated with this embodiment is that it is possible for, e.g. a record company, or some other type of content provider, to obtain access to the second channel to broadcast the encrypted secondary content. Where separate channels are used, it will be necessary to coordinate the primary content and the encrypted secondary content, such that an encrypted digitally storable copy of the primary content is transmitted on the second channel.

An extension to the concept of separate channels is that it is possible to allow a listener to request encrypted secondary content via, for example, SMS (Short Message Service) messages, or by means of paging.

The encrypted first key may still be sent through the primary channel to tie the opportunity to download to a specific radio show, thus attracting listeners and making the channel/show more attractive to advertisers. Advertisers may even sponsor the sale of secondary content, e.g. if the key is transmitted during their commercial.

Turning to FIG. 4, according to another embodiment of the present invention, the broadcaster 400 transmits the primary content and the encrypted secondary content on the same channel 401 (and the receiver 403 thereby receives the content on one channel). The broadcaster can, by using a single transmission channel for the primary and the encrypted secondary content, avoid various types of overhead, which will arise when using separate channels.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of acquiring content from an information transmission (101), the method comprising the steps of:
receiving (102) the information transmission comprising a first content and an encrypted second content, which second content is a digitally storable copy of the first content;
extracting the encrypted second content comprised in the information transmission when a receiver (103) of the information transmission effects an extracting operation;
storing the encrypted second content at the receiver;
extracting a first decryption key, which is comprised in the received information broadcast (102), for decrypting the encrypted second content; and
enabling decryption of the encrypted second content, whereby the second content is made renderable.

2. (canceled)

3. The method according to claim 1, wherein said first decryption key is encrypted and the method further comprises the step of:
acquiring, from a content provider, a second decryption key for decrypting the encrypted first decryption key.

4. The method according to claim 1, wherein the first content and the encrypted second content are received on separate channels (301, 302).

5. The method according to claim 3, wherein the first content and the encrypted second content are coordinated with each other on said separate channels (301, 302).

6. The method according to claim 1, wherein the first content and the encrypted second content are received on the same channel (401).

7. The method according to claim 1, wherein the information transmission (101) is an information broadcast.

8. A device (103) for acquiring content from an information transmission (101), the device comprising:
means (104) for receiving the information transmission, which transmission comprises a first content and an encrypted second content, the second content being a digitally storable copy of the first content;
means (105) for extracting the encrypted second content comprised in the information transmission, when the device is operated to effect an extracting operation;
means (203) for storing the encrypted second content at the device;
means (105) for extracting a first decryption key, which is comprised in the received information broadcast (102), for decrypting the encrypted second content; and
means (105) for enabling decryption of the encrypted second content, whereby the second content is made renderable.

9. (canceled)

10. The device (103) according to claim 8, wherein said first decryption key is encrypted and the decrypting means is further arranged to decrypt the encrypted first decryption key with a second decryption key.

11. The device (103) according to claim 8, wherein the receiving means (104) is further arranged to receive the first content and the encrypted second content on separate channels (301, 302).

12. The device (103) according to claim 8, wherein the receiving means (104) is further arranged to receive the first content and the encrypted second content on the same channel (401).
